(19) United States
(12) Patent Application Publication
(10) Pub. No.: US 2026/0196059 A1
(43) Pub. Date: Jul. 9, 2026

(54) MULTI-VIEW CLOUD MERGING VIA REGISTRATION NEURAL NETWORK

(71) Applicant: Valeo Schalter und Sensoren GmbH, Bietigheim-Bissingen (DE)

(72) Inventors: Xinhua Xiao, Troy, MI (US); Ronald Nap, Troy, MI (US); Nathaniel Haynam, Troy, MI (US)

(21) Appl. No.: 19/009,270

(22) Filed: Jan. 3, 2025

(51) Int. Cl. G06V 20/58; G01C 21/36; G06V 10/26; G06V 10/75; G06V 10/77; G06V 10/82; G06V 20/70

(52) U.S. Cl. CPC G06V 20/586; G01C 21/3602; G01C 21/3685; G06V 10/26; G06V 10/75; G06V 10/7715; G06V 10/82; G06V 20/70

(57) ABSTRACT

A method of performing feature matching to map an environment of a vehicle includes generating image-domain data based on image data received from a plurality of cameras mounted on the vehicle, the image-domain data including data corresponding to a plurality of images, performing feature extraction on a first image of the plurality of images to identify and extract features from the first image, performing segmentation on the first image to identify contours around the extracted features, embedding one or more patches in the first image based on the identified contours to obtain a merged image, providing the merged image to a vision transformer, and using the vision transformer to generate semantic descriptors for the merged image and perform feature matching to match, based on the semantic descriptors, the first image to a second image of the plurality of images.

### TECHNICAL FIELD

The present disclosure relates to systems and methods for parking zone mapping, vehicle localization, and assisting a vehicle to park using a neural network.

### BACKGROUND

Modern automotive vehicles are typically equipped with a variety of sensors. Whether internal or external to the passenger cabin of the vehicle, these sensors provide the foundation for driving automation and vehicle autonomy. Vehicles with autonomous or semi-autonomous driving or driver-assistant features use these sensors and associated computer vision technology to provide parking assistance. Parking assist systems can help drivers park their vehicles in parking spaces, automatically and/or by guiding the driver.

### SUMMARY

A method of performing feature matching to map an environment of a vehicle includes generating image-domain data based on image data received from a plurality of cameras mounted on the vehicle, the image-domain data including data corresponding to a plurality of images, performing feature extraction on a first image of the plurality of images to identify and extract features from the first image, performing segmentation on the first image to identify contours around the extracted features, embedding one or more patches in the first image based on the identified contours to obtain a merged image, providing the merged image to a vision transformer, and using the vision transformer to generate semantic descriptors for the merged image and perform feature matching to match, based on the semantic descriptors, the first image to a second image of the plurality of images.

In other aspects, one or more systems, processors or processing devices, computing devices, etc. are configured to perform functions corresponding to steps of various methods described herein.

In other aspects, a tangible, non-transitory computer-readable medium stores instructions that, when executed, cause one or more processors or processing devices to perform any operation of any method described herein.

### BRIEF DESCRIPTION OF THE DRAWINGS

FIG. 1 illustrates a block diagram depicting an example system of mapping and localizing a parking zone using a mixed-domain neural network according to the principles of the present disclosure.

FIG. 2 illustrates an example operational diagram for implementing the system of FIG. 1 according to the principles of the present disclosure.

FIG. 3 illustrates an example operational diagram for implementing the system of FIG. 1 according to the principles of the present disclosure.

FIG. 4 illustrates an example schematic flow chart for assisting a vehicle to park using the system of FIG. 1 according to the principles of the present disclosure.

FIG. 5 illustrates a flow diagram of an example method of assisting a vehicle to park using mixed-domain image data according to the principles of the present disclosure.

FIG. 6 is an example cloud merging process according to the principles of the present disclosure.

FIG. 7 is an example feature matching process according to the principles of the present disclosure.

FIG. 8 illustrates a block diagram of a vehicle electronics control system according to the principles of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Some portions of this description describe the embodiments of the disclosure in terms of algorithms and operations. These operations are understood to be implemented by computer programs or equivalent electrical circuits, machine code, or the like, examples of which are disclosed herein. Furthermore, these arrangements of operations may be referred to as modules or units, without loss of generality. The described operations and their associated modules or units may be embodied in software, firmware, and/or hardware.

Steps, operations, or processes described may be performed or implemented with one or more hardware or software modules, alone or in combination with other devices. Although the steps, operations, or processes are described in sequence, it will be understood that in some embodiments the sequence order may differ from that which has been described, for example with certain steps, operations, or processes being omitted or performed in parallel or concurrently.

References herein to a “parking zone” should be construed to include parking lots, parking garages, streets with parking spots (e.g., parallel or angled parking spots next to a drive lane on a road), and other similar spaces where several parking spots are concentrated or grouped together. A parking zone can include a physical area that is established for parking, storing, or keeping a vehicle for a period of time. The parking zone can include one or more markers, lines, signs, or other indications to facilitate parking or define aspects of the parking zone. For example, the parking zone may or may not include parking lines that define or allocate a physical area or space in which a vehicle is to park. The parking lot can include signs that provide parking restrictions, such as types of vehicles that can park in a parking space or spot (e.g., small vehicle, mid-size vehicle, full size vehicle, sports utility vehicle, truck, hybrid, electric vehicle), requirements (e.g., handicap sticker), or time constraints (e.g., 1 hour parking, 2 hour parking).

It is nearly ubiquitous for modern vehicles to be equipped with a variety of sensors. Whether internal or external to the passenger cabin of the vehicle, these sensors provide the foundation for driving automation and vehicle autonomy. Vehicles with autonomous or semi-autonomous driving or driver-assistant features can use these sensors and associated computer vision technology to provide parking assistance. Parking assist systems can help drivers park their vehicles in parking spaces, either automatically or guiding the driver to do so. However, in order to find an available parking space in a parking zone, a vehicle typically must enter the parking zone whereupon the vehicle's sensors or the driver drives back and forth within the parking zone while visually scanning for unoccupied parking spots. This can be tedious and time-consuming, leading to frustration and unwanted fuel consumption.

Recent advancements in parking assist systems have attempted to solve this problem. One solution involves a “virtual valet” whereupon the driver can exit the vehicle and allow the vehicle to enter an autonomous, self-parking mode. In this mode, the vehicle will travel in the parking zone in search of an available parking spot. This allows the driver to save time while the vehicle parks, but still leads to unwanted fuel consumption if the vehicle must travel about the parking zone in search of an available spot.

Simultaneous localization and mapping (SLAM) is a technology a vehicle can employ for building up a map of an unknown environment or scene, or updating the map of a known environment, while at the same time calculating the vehicle's position and/or location in the environment. Visual-SLAM (VSLAM) involves using cameras as sensors to create the map and localize. Objects (e.g., other vehicles, pedestrians, lane lines, etc.) can be detected in, and extracted from, the camera images. This can be carried over to a parking zone. For example, a vehicle's camera system along with feature recognition can be used to map a parking lot via SLAM.

However, vehicle SLAM systems typically rely on global positioning system (GPS) to aid in mapping and localization. When the GPS signal is weak or non-existent (such as when the vehicle is in a rural environment, or underground or in a garage), global mapping of the environment can be difficult. The mapping can be conducted with low-cost sensors, cameras and inertial measurement units (IMUs) which are not robust enough because their performance is influenced by lighting conditions and moving objects. Underground parking or parking garages are prime examples where lighting conditions are low and there are not many (if any) moving objects.

In some examples, mapping and localization can be performed based on a mixed-domain neural network with a two-pathway learning solution. Using vehicle cameras for example, the mapping and localization can be performed based on image data that is in an image domain (e.g., raw or only pre-processed image), and image data that is in a bird's-eye-view (BEV) domain (e.g., top-down view, projected image). A BEV can be created based on the vehicle camera images. Both the image data in the image domain and the image data in the BEV domain can be integrated into the neural network for respective localization and mapping techniques. This can be done without GPS or IMU data, but certainly that data can be used if available to increase accuracy. These examples provide an increased range of detection considering the camera field of view and resolution. For example, BEV enables an accurate local view because the system can obtain highly localized output of the vehicle's location corresponding to the surrounding environment (e.g., parking lanes, walls, bumpers, pillars, etc.). However, the BEV domain is not as accurate for environmental objects that are further away from vehicle. In the BEV domain, because multiple (e.g., four) images are stitched together to form the BEV, images can get distorted. Therefore, in an example embodiment, objects or other image points in the image domain can be used to build a global or larger map of the parking zone, while objects or other image points in the BEV domain can be used to build a local map of the environment immediately surrounding the vehicle. This allows for the creation of a large map of a parking zone that can also have details of localized map features from the BEV image domain.

When creating maps using structure from motion on different sequences of images sourced from different cameras (e.g., front, rear, left, right, etc.), multiple point clouds can be created from the same scene. However, while this sparse 3D representation generally models the same real-world structure, variations in distortion caused by the different cameras and noise makes it difficult to merge the point clouds so that two points from separate objects that correspond to the same ground truth are mapped to the same cluster and correct spatial relationship. In other words, it can be difficult to ensure that a point at the bottom of a stop sign in one cluster is mapped to the same stop sign in another cluster where only access to points at the top of that stop sign are available. Example methods such as Open3D utilize ICP (Iterative Closest Point) and global registration techniques, but these can be computationally intensive and may struggle with low overlap and noise.

Advanced methods such as deep learning-based approaches for feature extraction and matching or multi-view convolutional neural networks (CNNs) for capturing global context can offer more robust and efficient solutions for accurate point cloud alignment and merging. Furthermore, structure from motion algorithms such as COLMAP, fail to create merged sparse reconstructions from multiple sequences of images from separate fisheye cameras. However, these methods are not robust across different camera types (e.g., pinhole and fisheye cameras) and have higher inference cost in terms of time and computation.

Systems and methods according to the present disclosure are configured to implement neural network-based cloud merging techniques to merge multi-view point clouds by learning transformation parameters that map points from one cloud to another. These techniques involve using deep learning models trained on pairs of point clouds to predict translation vectors, rotation matrices, and scale factors. Example advantages of these cloud merging techniques include:
robustness to noise and variations in input point clouds, ensuring accurate merging even in challenging environments;
preservation of the initial spatial relationships of objects within the point clouds, maintaining object integrity with state of the art accuracy;
enhanced accuracy and efficiency, reducing computational overhead; and
compatibility with different camera types, allowing processing of point clouds from pinhole and fisheye cameras with reduced computational costs.

In some examples, geometric feature matching methods are implemented, which suffer from high inference times, limited scalability, and lack of semantic information. These methods are computationally intensive, running primarily on a processor (e.g., a central processing unit, or CPU) and making it challenging to share information between vehicles.

Accordingly, systems and methods according to the present disclosure may be further configured to implement feature matching techniques that leverage the scalability of vision transformers (ViTs) to enhance the accuracy and robustness of feature matching. By utilizing semantic information, feature matching techniques of the present disclosure enrich the learned semantic descriptors generated by the ViT and employ semantic feature extraction to filter relevant features per image at test time. This approach shifts the computational burden to a graphics processing unit (GPU), reducing CPU usage and resulting in more accurate feature matching with reduced inference times.

In this manner, semantic segmentation is used to filter and enrich feature points before processing them through the ViT. In an example, feature points are extracted using scale invariant feature transform (SIFT) or semantic feature extraction techniques, which are then enhanced by segmentation to improve contrast and detectability. This segmentation is merged with the original image, providing more apparent feature points for matching. A patch around each feature point is then taken as input to the ViT. Utilizing the segmentation, semi-supervised triplet matching is performed, where the anchor is the crucial point in the source image, the positive is a transformation of the original image patch, and the negative is a randomly selected feature point from a different class. For fine-tuning, the positive can be a future image feature point, with frameshift and segmentation contours adjustments, while the negative is shifted to a random feature point of the same class, enriching the descriptor space. With the triplet database of semantic features, the ViT is trained using triplet loss or other contrastive loss techniques.

This self-supervised training allows for high scalability, requiring only a sequence of images of interest. The trained ViT outputs semantic descriptors, which are matched using similarity metrics such as Euclidean distance or cosine similarity. This method ensures efficient and accurate feature matching even in complex and dynamic scenes. Additionally, by integrating lightweight models (e.g., ESPNetV2) for segmentation and using efficient matching algorithms, the feature extraction techniques of the present disclosure achieve real-time performance suitable for applications requiring quick and reliable feature matching. Accordingly, the systems and methods of the present disclosure provide a scalable, accurate, and robust solution for feature matching, significantly improving upon existing methods in terms of performance and applicability in challenging environments.

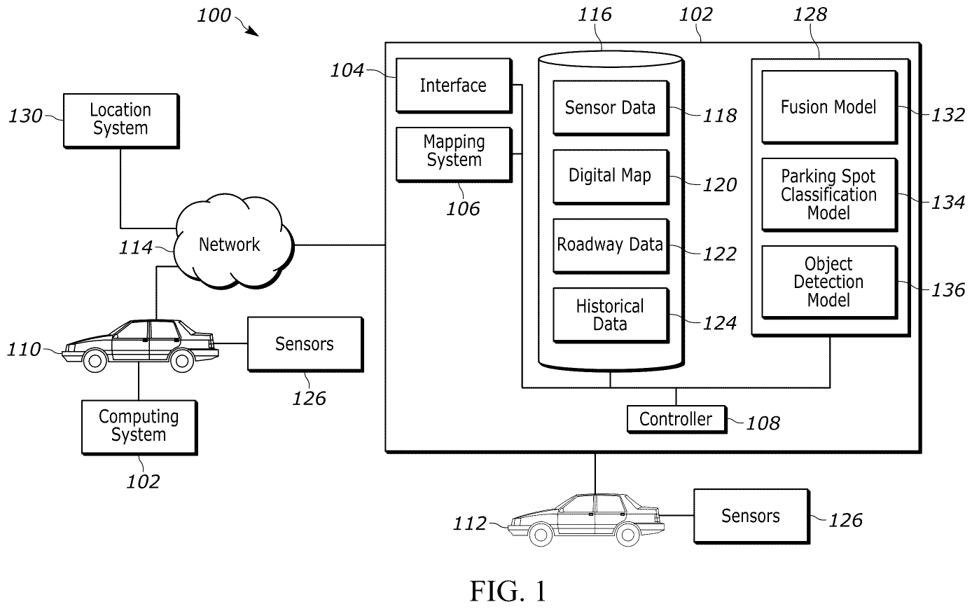

FIG. 1 illustrates a block diagram depicting an example system 100 of mapping of, and localizing with, a parking zone using a mixed-domain neural network. The system 100 can also be used for assisting a vehicle to park based on parking-spot availability data. For example, U.S. patent application Ser. No. 18/221,097 (filed Jul. 12, 2023 and titled METHODS AND SYSTEMS FOR PARKING ZONE MAPPING AND VEHICLE LOCALIZATION USING MIXED-DOMAIN NEURAL NETWORK), the entirety of which is hereby incorporated by reference herein, is directed to methods and systems for assisting a vehicle to park based on real-time parking spot availability data; the mapping and localization techniques disclosed herein can be incorporated into those disclosed methods and systems for assisting a vehicle to park based on real-time parking spot availability data, and vice versa.

The system 100 can include at least one computing system 102 for use in map generation and updating based on sensor data, stored data, and utilizing one or more machine-learning models. The computing system can include at least one interface 104, and at least one mapping system 106 for generating and updating a digital map of a parking zone, and at least one controller 108. The computing system 102 can include hardware or a combination of hardware and software, such as communications buses, circuitry, processors, communications interfaces, among others. The computing system 102 can reside on or within a corresponding vehicle (e.g., a host vehicle). For example, FIG. 1 shows a first vehicle 110 with a computing system 102 on-board, and a second vehicle 112 with another or similar computing system 102 on-board. Alternatively (or in addition), all or part of the computing system 102 can reside on a remote server (e.g., the cloud) which is communicatively coupled to the vehicles 110, 112 via a network 114. Each of the first vehicle 110 and the second vehicle 112 (or their corresponding computing system 102) can be communicatively connected to the network 114 to each other (e.g., via vehicle-to-vehicle (V2V) communication), to the cloud (e.g., via vehicle-to-cloud (V2C) communication), and/or to one or more other systems (e.g., a global positioning system (GPS), or to one or more communications devices). For example, the vehicles may include one or more transceivers configured to establish a secure communication channel with another vehicle or the remote server wirelessly using one or more communication protocols, such as, for example, communication protocol based on vehicle-to-vehicle (V2V) communications, wireless local area network (WLAN) or wireless fidelity (WiFi, e.g., any variant of IEEE 802.11 including 802.11a/b/g/n), wireless personal area network (WPAN, e.g., Bluetooth, Zigbee), cellular (e.g., LTE, 3G/4G/5G, etc.), wireless metropolitan area network WIMAN (e.g., WiMax), and other wide area network, WAN technologies (e.g., iBurst, Flash-OFDM, EV-DO, HSPA, RTT, EDGE, GPRS), dedicated short range communications (DSRC), near field communication (NFC), and the like. This enables the exchange of information and data that is described herein.

The computing system 102 can also include at least one data repository or storage 116. The data repository 116 can include or store sensor data 118 (originating from the sensors described herein), a digital map or digital map data 120, parking data 122, and historical data 124. The sensor data 118 can include information about available sensors, identifying information for the sensors, address information, internet protocol information, unique identifiers, data format, protocol used to communicate with the sensors, or a mapping of information type to sensor type or identifier. The sensor data 118 can further include or store information collected by vehicle sensors 126. The sensor data 118 can store sensor data using timestamps and date stamps. The sensor data 118 can store sensor data using location stamps. The sensor data 118 can categorize the sensor data based on a parking zone or characteristics of a parking zone.

Vehicle sensors 126 that generate the sensor data 118 can include one or more sensing elements or transducers that captures, acquires, records or converts information about its host vehicle or the host vehicle's environment into a form for processing. The sensor 126 can acquire or detect information about parking zones. The sensor 126 can detect a parking zone condition such as a road feature, boundary, intersection, lane, lane marker, or other condition. The sensor 126 can also detect a feature of a particular parking space, such as symbols that represent the parking space is for handicapped, emergency vehicles only, pregnant women (expectant mothers), and the like. The sensor 126 can, for example, acquire one or more images of the parking zone, which can be processed using image processing and object recognition to identify or detect features indicative of a parking zone, e.g., a parking sign, a stop sign, a handicap parking sign, or surface markings on a parking zone. As examples, the sensor 126 can be or include an image sensor such as a photographic sensor (e.g., camera), radar sensor, ultrasonic sensor, millimeter wave sensor, infra-red sensor, ultra-violet sensor, light detection sensor, lidar sensor, or the like. The sensor 126 can communicate sensed data, images or recording to the computing system 102 for processing, which can include filtering, noise reduction, image enhancement, etc., followed by object recognition, feature detection, segmentation processes, and the like. The raw data originating from the sensors 126 as well as the processed data by the computing system 102 can be referred to as sensor data 118 or image data that is sensed by an associated sensor 126.

The sensors 126 can include panoramic cameras, pinhole cameras, or the like that are mounted to a vehicle. The images generated from these cameras can be in various domains, such as an image domain (also referred to as a raw image), or a BEV domain (also referred to as a top-down view or a projected image). Images stitched together to form the BEV image can also be subjected to neural network processing (e.g., feature detection) as part of the BEV domain processing.

The sensor 126 can also include a global positioning system (GPS) device that can determine a location of the host vehicle relative to an intersection, using map data with an indication of the parking zone. The GPS device can communicate with location system 130, described further below. The computing system 102 can use the GPS device and the map data to determine that the host vehicle (e.g., first vehicle 110) has reached the parking zone. The computing system 102 can use the GPS device and the map data to determine the boundaries of the parking zone. The sensor 126 can also detect (e.g., using motion sensing, imaging or any of the other sensing capabilities described herein) whether any other vehicle or object is present at or approaching the parking zone, and can track any such vehicle or object's position or movement over time for instance. The sensor 126 can also detect the relative position between another vehicle and a parking spot, e.g., whether or not a parking spot is occupied by a vehicle as indicated by at least a portion of the vehicle being between the boundaries of two adjacent parking spot lines. However, the mapping and localization techniques disclosed herein can be performed without GPS data.

Using any one or more of the aforementioned types of sensors 126, the vehicle (e.g., first vehicle 110) is able to virtually map the parking zone. For example, the sensors calculate relative distances between detected objects and the sensor itself, and the computing system 102 can utilize a visual simultaneous localization and mapping (SLAM) system. Visual SLAM is a position detecting scheme in which a process of generating a digital map of an environment (such as a parking zone) and a process of acquiring a location of the sensor or vehicle itself are complementarily performed. In other words, characteristics of the environment about the vehicle as well as the location of the vehicle itself are determined simultaneously.

The mapping system 106 can implement visual SLAM (or similar technologies) to generate a digital map of the parking zone. The mapping system 106 is designed, constructed or operational to generate digital map data based on the data sensed by the one or more sensors 126. The digital map data structure (or referred to as digital map 120) can generate the digital map from, with or using one or more machine learning models or neural networks established, maintained, tuned, or otherwise provided via one or more machine learning models 128. The machine learning models 128 can be configured, stored, or established on the computing system 102 of the first vehicle 110, or on a remote server. The mapping system 106 can detect, from a first neural network and based on the data sensed by the one or more sensors 126, objects located at the parking lot. The mapping system 106 can perform, using the first neural network and based on the data sensed by the one or more sensors 126, scene segmentation. The mapping system 106 can determine, using the first neural network and based on the data sensed by the one or more sensors 126, depth information for the parking zone. The mapping system 106 can identify, from the first neural network 114 and based on the data sensed by the one or more sensors 126, one or more parking lines or parking spots in the parking zone. The mapping system 106 can construct the digital map based on the detected objects located at the parking zone, the scene segmentation, the depth information for the parking zone, and the one or more parking lines at the parking zone.

The mapping system 106 can create the digital map 120 based on the sensor data 118. This digital map 120 can be created via implemented visual SLAM, as described above. In one embodiment, the digital map 120 can include three dimensions on an x-y-z coordinate plate, and associated dimensions can include latitude, longitude, and range, for example. The digital map 120 can be updated periodically or reflect or indicate a motion, movement or change in one or more objects detected in the parking zone. For example, the digital map can include stationary objects associated with the scene, such as a curb, tree, lines, parking signs, or boundary of the parking zone, as well as non-stationary objects such as vehicles moving or a person moving (e.g., walking, biking, or running).

Various types of machine learning models 128 are disclosed herein. The machine learning model utilized by the mapping system 106 to generate the digital map 120 can include any type of neural network, including, for example, a convolution neural network, deep convolution network, a feed forward neural network, a deep feed forward neural network, a radial basis function neural network, a Kohonen self-organizing neural network, a recurrent neural network, a modular neural network, a long/short term memory neural network, or the like. Each machine learning model 128 can maintain, manage, store, update, tune, or configure one or more neural networks and can use different parameters, weights, training sets, or configurations for each of the neural networks to allow the neural networks to efficiently and accurately process a type of input and generate a type of output.

One or more of the disclosed machine learning models 128 disclosed herein can be configured as or include a convolution neural network. The convolution neural network (CNN) can include one or more convolution cells (or pooling layers) and kernels, that can each serve a different purpose. The convolution kernel can process input data, and the pooling layers can simplify the data, using, for example, non-linear functions such as a max, thereby reducing unnecessary features. The CNN can facilitate image recognition. For example, the sensed input data can be passed to convolution layers that form a funnel, compressing detected features. The first layer can detect first characteristics, the second layer can detect second characteristics, and so on.

The convolution neural network can be a type of deep, feed-forward artificial neural network configured to analyze visual imagery. The convolution neural network can include multilayer perceptrons designed to use minimal preprocessing. The convolution neural network can include or be referred to as shift invariant or space invariant artificial neural networks, based on their shared-weights architecture and translation invariance characteristics. Since convolution neural networks can use relatively less pre-processing compared to other image classification algorithms, the convolution neural network can automatically learn the filters that may be hand-engineered for other image classification algorithms, thereby improving the efficiency associated with configuring, establishing or setting up the neural network, thereby providing a technical advantage relative to other image classification techniques.

One or more of the disclosed machine learning models 128 disclosed herein can include a CNN having an input layer and an output layer, and one or more hidden layers that can include convolution layers, pooling layers, fully connected layers, or normalization layers. The one or more pooling layers can include local pooling layers or global pooling layers. The pooling layers can combine the outputs of neuron clusters at one layer into a single neuron in the next layer. For example, max pooling can use the maximum value from each of a cluster of neurons at the prior layer. Another example is average pooling, which can use the average value from each of a cluster of neurons at the prior layer. The fully connected layers can connect every neuron in one layer to every neuron in another layer.

To assist in generating the digital map 120, the computing system 102 can interface or communicate with a location system 130 via network 114. The location system 130 can determine and communicate the location of one or more of the vehicles 110, 112 during the performance of the SLAM or similar mapping techniques executed in generating the digital map 120. The location system 130 can include any device based on a positioning system such as Global Navigation Satellite System (GNSS), which can include GPS, GLONASS, Galileo, Beidou and/or other regional systems. The location system 130 can include one or more cellular towers to provide triangulation. The location system 130 can include wireless beacons, such as near field communication beacons, short-range wireless beacons (e.g., Bluetooth beacons), or Wi-Fi modules.

The computing system 102 can be configured to utilize interface 104 to receive and transmit information. The interface 104 can receive and transmit information using one or more protocols, such as a network protocol. The interface 104 can include a hardware interface, software interface, wired interface, or wireless interface. The interface 104 can facilitate translating or formatting data from one format to another format. For example, the interface 104 can include an application programming interface that includes definitions for communicating between various components, such as software components. The interface 104 can be designed, constructed or operational to communicate with one or more sensors 126 to collect or receive information, e.g., image data. The interface 104 can be designed, constructed or operational to communicate with the controller 108 to provide commands or instructions to control a vehicle, such as the first vehicle 110. The information collected from the one or more sensors can be stored as shown by sensor data 118.

The interface 104 can receive the image data sensed by the one or more sensors 126 regarding an environment or characteristics of a parking zone. The sensed data received from the sensors 126 can include data detected, obtained, sensed, collected, or otherwise identified by the sensors 126. As explained above, the sensors 126 can be one or more various types of sensors, and therefore the data received by the interface 104 for processing can be data from a camera, data from an infrared camera, lidar data, laser-based sensor data, radar data, transducer data, or ultrasonic sensor data. Because this data can, when processed, enable information about the parking zone to be visualized, this data can be referred to as image data.

The data sensed from the sensors 126 can be received by interface 104 and delivered to mapping system 106 for detecting various qualities or characteristics of a parking zone (e.g., parking lines, handicapped spaces, etc.) as explained above utilizing techniques such as segmentation, CNNs, or other machine learning models. For example, the mapping system 106 can rely on one or more neural networks or machine learning models 128 to detect objects, scene segmentation, roads, terrain, trees, curbs, obstacles, depth or range of the parking lot, parking line detection, parking marker detection, parking signs, or other objects at or associated with the parking zone. The computing system 102 can train the machine learning models 128 using historical data 124. This training can be performed remote from a computing process 102 installed on a vehicle 110, 112. In other words, the computing system 102 may be on a remote server for at least these purposes. Once trained, the models can be communicated to or loaded onto the vehicles 110, 112 via network 114 for execution.

Once generated, the digital map 120 can be stored in storage 116 and accessed by other vehicles. For example, the computing system 102 of a first vehicle 110 may be utilized to at least in part generate the digital map 120, whereupon that digital map 120 can be accessed by the computing system 102 of a second vehicle 112 that subsequently enters the parking zone. The computing system 102 of the second vehicle 112 (and other vehicles) can be utilized to update the digital map 120 in real-time based upon more reliable data captured form the second vehicle 112. In addition, the computing system 102 of both vehicles 110, 112 can be used to generate and continuously update parking data 122 in real-time. The parking data 122 represents data indicating characteristics of particular parking spots. For example, the parking data 122 can include a location of one or more parking spots, whether or not those parking spots are occupied or not occupied by a vehicle, and whether one or more of the parking spots are reserved for handicapped individuals, emergency vehicles only, vehicles carrying pregnant mothers, and the like, as described above. These qualities of the individual parking spots can be determined via the image data received from sensors 126 either when the digital map is generated, and/or when the digital map is updated by a second vehicle 112 or other vehicles. By updating the parking data 122 in real-time, a subsequent vehicle that enters the parking zone can be provided with live, accurate information about, for example, which parking spots are occupied or unoccupied.

As described above, one or more machine learning models 128 can be relied upon to perform the various functions described herein. These machine learning models 128 can include a fusion model 132, a parking spot classification model 134, an object detection model 136, and other models. The fusion model 132 is trained and configured to receive and fuse the image data 118, the digital map 120, and the parking data 122 and perform object detection and classification as described above, the results of which can be input into the parking spot classification model 134, for example. This can be executed with image data residing in the image domain and the BEV domain.

The parking spot classification model 134 is trained and configured to, based on the above data, perform image classification (e.g., segmentation) to generate and update parking data relating to the parking spaces of the parking zone. For example, the parking spot classification model 134 can be a machine learning model that determines whether each parking spot is a normal parking spot, a handicapped parking spot, a charging station for an electric vehicle (and, for example, whether that charging station is for wireless charging or charging by cable), and/or whether each parking spot has an allowed duration of parking (e.g., 1 hour, 2 hours, etc.). The output of this parking spot classification model 134 can be used to update the digital map 120 and parking data 122 if necessary.

The objection detection model 136 is trained and configured to, based on the above data, detect objects or obstacles in the parking zone. This can include parking lines used to determine whether a parking spot is present. The objection detection model 136 can, for example, determine the presence of a vehicle in a parking spot, thus enabling a determination that a parking spot is occupied. The objection detection model 136 can also determine the presence of a pothole, cone, debris, or other object in the parking zone, which can be stored in storage 116 and communicated to other vehicles (e.g., vehicle 112) that subsequently enter the parking zone.

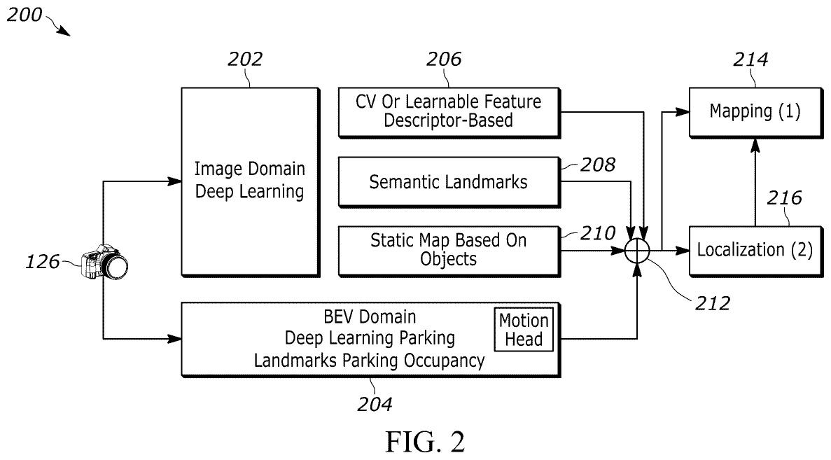

FIG. 2 illustrates an example operational diagram 200 for implementing the system of FIG. 1, according to an embodiment. This operational diagram can be for a system of simultaneously localizing and mapping based on a mixed-domain neural network. The various operations illustrated here can be performed by one or more systems, components, or functions depicted in FIG. 1. For example, the operations can be performed by computing system 102, mapping system 106, controller 108, and the various machine learning models 128 disclosed above. At 202, image data in the image domain (e.g., raw image, preprocessed, not significantly modified) is received from a sensor 126. In an embodiment, the sensor 126 includes one or more cameras, such as a fisheye camera or pinhole camera mounted on a vehicle.

The image data generated from the sensor 126 can also be used to create a bird's-eye-view (BEV) image with associated data that is in the BEV domain 204. In an embodiment, the BEV is formed by stitching together multiple camera images, and distorting those images to appear as if a virtual camera is positioned above the vehicle looking down on the vehicle and its surroundings.

The image data in the image domain 202 can be processed with a computer vision (CV) machine learning model 206 implementing feature-based descriptors. In an embodiment, the CV model 206 utilizes an Oriented FAST and rotated BRIEF (ORB) version of SLAM, or ORB-SLAM. ORB-SLAM is a computer vision-based system using ORB features whose descriptor provides short-term and mid-term data association, builds a covisibility graph to limit the complexity of tracking and mapping, and performs loop closing and relocalization, achieving long-term data association.

In another embodiment, the CV model 206 utilizes a Learned Invariant Feature Transform (LIFT) version of SLAM, or LIFT-SLAM. LIFT-SLAM is a deep-learning feature-based monocular VSLAM system that reconstructs sparse maps that are graph-based and keyframe-based, allowing the performance of bundle adjustment to optimize the estimated poses of the cameras. LIFT is a deep neural network (DNN) that implements local feature detection, orientation estimation, and description in a supervised end-to-end approach in which three main modules based on CNNs are used: detector, orientation estimator, and descriptor. The LIFT algorithm works with patches of images; after giving a patch as input, the detector network provides a score map of this patch. A soft argmax operation is performed over this score map to return the potential feature point location. Then, the algorithm performs a crop operation centered on the feature location, used as input to the orientation estimator which predicts an orientation to the patch. Thus, a rotation is applied in the patch according to the estimated orientation. The descriptor network computes a feature vector from the rotated patch, which is the output.

In another embodiment, the CV model 206 relies upon parts of an autonomous valet parking (AVP) SLAM, or AVP-SLAM. AVP-SLAM incorporates semantic features (e.g., guide signs, parking lines, speed bumps, etc.) which typically appear in parking zones. These semantic features are exploited to build the map and localize the vehicle in the parking zone. Compared with traditional features, these semantic features are long-term stable and robust to the perspective and illumination change.

Building upon this system, semantic landmarks are extracted from the image-domain data at 208. In one example, at 208 the image-domain data can be processed with a CNN configured for semantic segmentation (e.g., pixel-wise labeling) of the image. For example, DeepLab, S-Unet, or other semantic segmentation models can be used. Here, various semantic landmarks that are mostly long-term and stable within a parking zone can be identified. Examples of such semantic landmarks labeled can include parking lanes, walls, bumpers, pillars, road markers, signs, arrows, and the like.

The image-domain data can also be processed to generate a static map at 210. Here, an object detection model can detect static objects such as trees, poles, curbs, borders, cones, parked cars, and the like. The static map can consume some information of semantic landmarks. Poles, curbs, and the like are static objects (as opposed to dynamic objects) that do not change position from one iteration to another, and also help identify landmarks within the map used for parking purposes. These objects are therefore good candidates for digestible information for the generation of a static map.

Meanwhile, the BEV-domain image data is processed at 204. Parking landmarks can be determined based on the BEV-domain image data. For example, parking lines, vehicle orientation, drivable areas, and parking occupancy (i.e., the detection of another vehicle in a parking spot) can be determined based on the BEV-domain image data. Neural network(s) can process the image data from a fusion of fisheye and pinhole cameras, for example. BEV semantic segmentation can be utilized to take camera views as input and predict a rasterized map with surrounding semantics under the BEV view. Depth estimation can be included, injected with auxiliary 3D information. This can be performed via local self-similarity (LSS), SimpleBEV, BEVFusion, LaRa, BEVDet, or the like. Centroidal Voronoi tessellation (CVT) can also be utilized, which develops positional embeddings for each individual camera depending on its intrinsic and extrinsic calibrations. BEVFormer can also be used, which exploits the camera intrinsic and extrinsic explicitly to compute the spatial features in the regions of interest of the BEV grid across camera views using deformable transfer.

At 212, a feature integration module is utilized to integrate the image-domain image data and the BEV-domain image data. Here, in embodiments, the features in the BEV-domain image data and the image-domain image data are used together for tracking and pose estimation, and generating the trajectory based on the poses and tracking. The features are transferred from vehicle coordinates into the world coordinates in order to generate local maps. If two local maps match successfully, the relative pose between the two local maps is obtained. Globally-consistent maps are generated by stacking local maps together by updating poses after global pose graph optimization. In the global pose graph optimization, there can be loop closure and odometry constrains to handle the drive of the mapping. Thus, BEV domain mapping and image domain mapping are combined.

With the integrated image-domain image data and BEV-domain image data, a SLAM algorithm or process can be utilized. In particular, mapping can be performed at 214 according to the examples and descriptions provided above. Here, a map of the parking zone is generated (or updated) based upon the detected objects and processing of the image-domain image data and the BEV-domain image data. Simultaneously, localization can be performed at 216 based on the same. The localization data can also be used for the mapping. Both the localization 216 and mapping 214 can be implemented using the mapping system 106 described above, such as a SLAM system for example.

In both mapping 214 and localization 216, image data can be relied upon without the need for GPS or other sensors. The lack of GPS can be due to the vehicle being within the parking zone which blocks or interferes with the GPS signal. However, the present disclosure is not limited to such. Indeed, additional sensors (e.g., lidar, radar, IMU, GPS) can be utilized to further improve the mapping and/or localization.

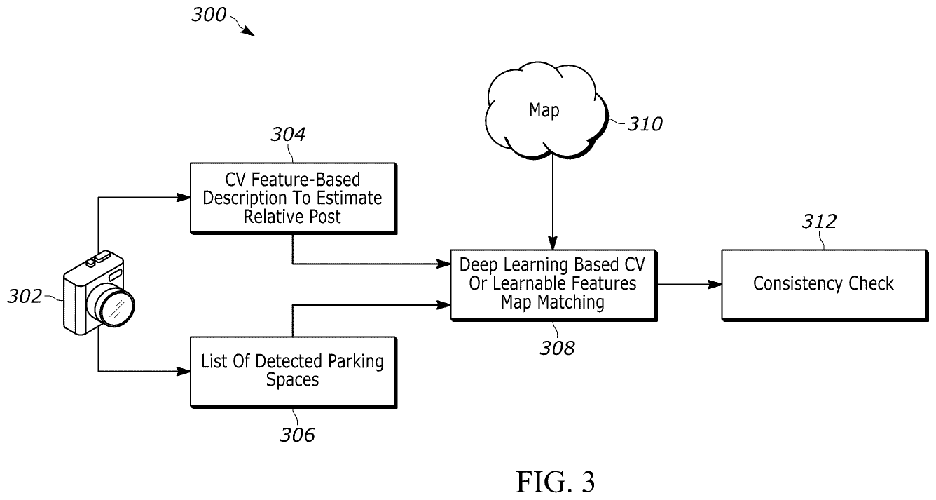

FIG. 3 illustrates an example operational diagram 300 for implementing the system of FIG. 1, according to an embodiment. Once again, the various operations illustrated here can be performed by one or more systems, components, or functions depicted in FIG. 1. For example, the operations can be performed by computing system 102, mapping system 106, controller 108, and the various machine learning models 128 disclosed above. At 302, the system (e.g., system 100) receives image data. The image data may be associated with a BEV image, which can be generated according to the teachings above. For example, the BEV image at 302 may be generated from the raw image data.

At 304, the system can implement the CV machine learning model similar to 206 described above. Here, feature-based descriptions are generated to estimate a relative pose of the vehicle and/or its surroundings. This can be performed in real-time while the vehicle is in the parking zone. Further, at 306, the system can generate a list of detected parking spaces or slots. This can be based on the determined presence of parking lines with no vehicle located between the parking lines, for example, based on the BEV-domain image data.

At 308, the system can perform deep learning-based CV or learnable features map matching. This can be executed based on both the feature-based description from 304 and the list of detected available parking spaces or slots from 306, along with a map or map data 310. The map or map data 310 may be generated from a previous vehicle that traveled through the parking zone, for example. One example of a machine learning model implemented at 308 is DelS-3D, a Deep Localization and Segmentation with a 3D Semantic Map. Further, the system can implement loop detection to identify places that were previously visited by that vehicle or another vehicle, and perform loop closure to align the current scan to the previously visited place and accordingly correct the map. A loop closure detection such as LCDNet can be implemented to reduce the drift accumulated over time by adding a new constraint to the pose graph when a loop is detected. Consistency between the previously-generated scan with the currently-generated scan is thus performed at 312.

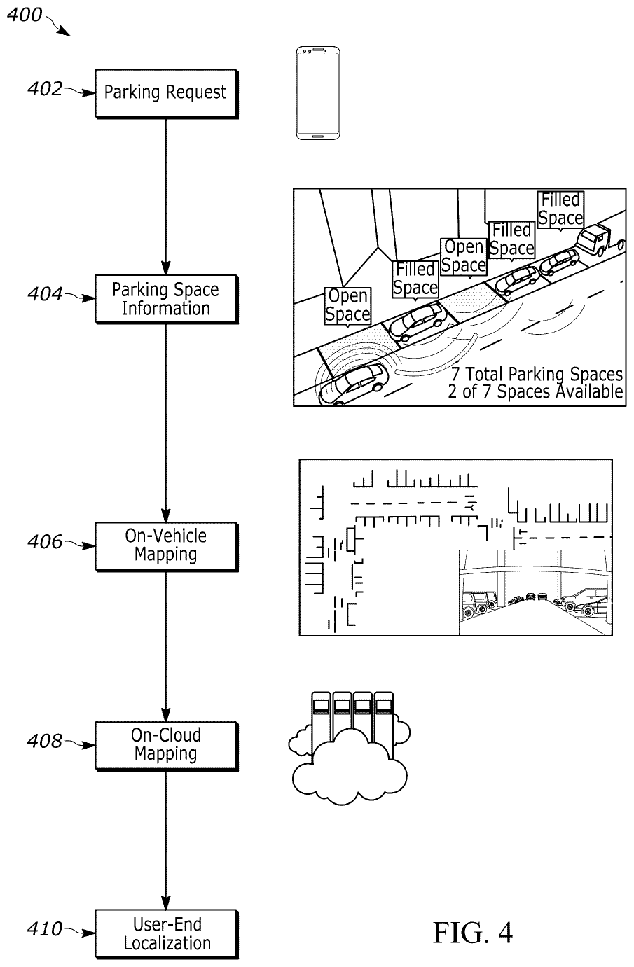

FIG. 4 illustrates an example schematic flow chart 400 for assisting a vehicle to park, according to an embodiment. Once again, the various operations illustrated here can be performed by one or more system, component, or function depicted in FIG. 1. For example, the operations can be performed by computing system 102, mapping system 106, controller 108, and the various machine learning models 128 disclosed above. At 402, the computing system 102 can receive a parking request from a user. For example, a user can exit his or her vehicle, and request that the vehicle park itself without a driver in the vehicle. This can be done by interacting with an app on a mobile device (e.g., smart phone, tablet, etc.) and request his or her vehicle to park autonomously. This allows the driver of the vehicle to save time by being able to exit the vehicle and tell the vehicle to park itself rather than driving around in the vehicle to manually perform the parking operation.

The parking request may be sent from the user interacting with the mobile device. Alternatively, the parking request may be sent from the user interacting with a vehicle display (e.g., infotainment screen, dashboard screen, or the like). The parking request may also be sent automatically from the computing system in response to a determination (e.g., via GPS or the like) that the vehicle is entering or proximate a parking zone. The parking request can be made through an interface that connects to the cloud to access live dynamic map information associated with the parking zone.

At 404, the computing system obtains or determines parking space information. Here, the computing system can determine the total number of parking spaces in the parking zone, the number of spaces available (unoccupied), the types of spaces available (e.g., handicapped, paved, battery charging, etc.). The vehicle entering the parking zone can determine this information. Alternatively, the vehicle entering the parking zone can obtain this information from the cloud or V2V communication from other vehicles that previously entered the parking zone. In an embodiment, the user's vehicle travels (e.g., autonomously) through the parking zone, and performs one or more of the following techniques or tasks: parking spot detection and status (e.g., determining whether a parking spot is empty or occupied), parking spot classification (e.g., determining which type of parking spot, such as handicapped, battery charging, etc.), parking spot sign recognition (e.g., learning contextual information about temporary signage or parking posts), parking lot obstacle detection (e.g., determining presence and location of pillars, walls, curbs, bumpers, and the like explained above), and parking lot road conditions (e.g., presence and location of surface hazards, debris, garbage, snot, water, ice, cracks, potholes, etc.). These are merely examples of tasks to be performed. These and other tasks may be performed utilizing the machine learning models 128 described above based on image data associated with images captured from the vehicle sensors 126.

At 406, the computing system performs on-vehicle mapping, e.g. semantic mapping creation and map change detection. As an example, the computing system can execute VSLAM, including a combination of image data, IMU data, GPS data (if available) to perform mapping and localization. The computing system can also determine whether the inventory of vehicles has changed within the parking zone. For example, whether the parking lines have changed, whether new colors are present in the lines or markers, or whether any of the marking or static objects have changed. This can be performed by comparing the live data to the data received from the cloud (e.g., V2C).

At 408, the computing system facilitates or supplements on-cloud mapping. Here, the computing system can stream data to the map stored on the remote server (cloud), whereupon the remote server can merge the data detected from the vehicle with the data stored previously on the remote server. This can allow the cloud mapping system to update the stored map data so that a subsequent vehicle is given the most up-to-date information of the parking zone.

At 410, the computing system performs user-end localization. For example, the VSLAM can perform localization based on data received to given to the on-cloud mapping process. The computing system can also perform data fusion to provide parking spot status or category changes. The computing system can receive information from the on-cloud mapping to perform dynamic map updates over the cloud by streaming updated localization and other data to the remote server.

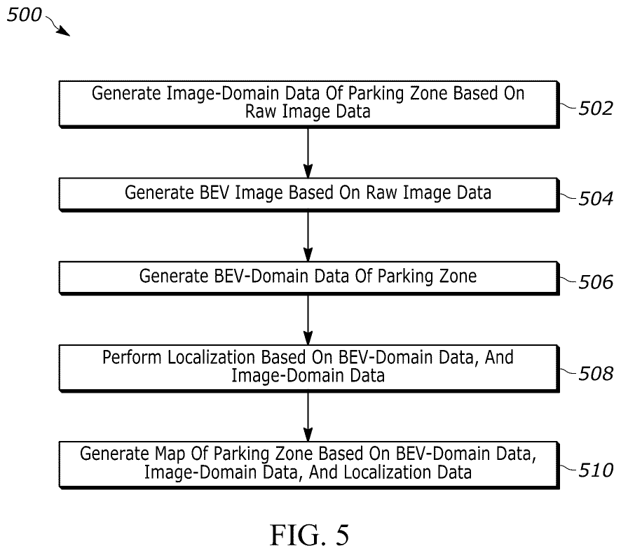

FIG. 5 illustrates an example method or process 500 of assisting a vehicle to park using mixed-domain image data. The method may be performed via the computing system 100 described herein, for example. At 502, one or more processors of the computing system generates image-domain data of a parking zone based on raw image data. The raw image data can be received from a plurality of sensors 126, such as cameras, mounted about the vehicle. The image-domain data can be generated by a feature-detection machine learning model, such as those described herein.

At 504, one or more processors of the computing system generates a bird's-eye-view (BEV) image based on the raw image data from 502. The BEV image may be a projected image of the parking zone, and may be generated by stitching together multiple images from a respective number of cameras. At 506, the one or more processors generate corresponding BEV-domain data associated with the BEV image from 504. The BEV-domain data includes data associated with parking landmarks in the parking zone, such as poles, pillars, parking lines, and those explained above.

At 508, the computing system performs a localization of the vehicle within the parking zone based on the BEV-domain data and the image-domain data in order to generate localization data. At 510, which may be performed simultaneously with 508, the computing system can perform a mapping of the parking zone based on the BEV-domain data, the image-domain data, and the localization data. The mapping can result in a digitally-generated map of the parking zone, the data of which can be transferred to a remote server for updating of a server-stored map.

As described above, systems and methods according to the present disclosure are configured to generate maps using images obtained by different cameras. However, when using sequences of images from different cameras, multiple point clouds can be created from the same scene. Systems and methods according to the present disclosure are configured to implement cloud merging (e.g., “multi-view point cloud merging”) techniques to merge multi-view point clouds by learning transformation parameters that map points from one cloud to another. These techniques involve using deep learning models trained on pairs of point clouds to predict translation vectors, rotation matrices, and scale factors as described below in more detail.

The techniques of the present disclosure facilitate multi-view point cloud merging from noisy or filtered point cloud inputs. In an example, structures from motion algorithms (e.g., COLMAP) are used to create point clouds from single camera image sequences (e.g., camera image sequences from different cameras/sensors). Alternatively, point clouds can be generated from a variety of sensors or sensor fusion techniques (e.g., images obtained using camera, radar, lidar, etc). These separate point clouds can optionally be filtered and given semantic labels.

The sparse point clouds (e.g., multi-view 3D point clouds) obtained from the different cameras and, optionally, camera/multi-sensor extrinsics (extrinsic data), are provided to a registration network (e.g., a registration neural network). The registration neural network is configured to learn/determine, based on the point clouds obtained from the images from different cameras, a global translation vector, a rotation matrix, and a scale to effectively map one point cloud onto another, preserving initial spatial relationships of both point clouds on an object-to-object basis. In other words, point locations on individual objects in the point clouds are preserved, object position relative to other objects is preserved, and any distortion resulting from different the images being captured from different cameras is removed.

The registration neural network trained as described above is configured to minimize a Euclidean distance between a point from a target point cloud and a point from a source point cloud (e.g., using mean squared error, or MSE, techniques), learning a correct transformation to map the target point cloud onto the source point cloud.

In some examples, K-Nearest-Neighbors (e.g., meshing, smoothing, graph neural network, etc.) techniques can be used to add semantic labels to the target point cloud from the nearest labeled point in the source point cloud if labels are not provided in the target point cloud.

In this manner, the cloud merging techniques of the present disclosure can be used to effectively merge two point clouds from images from different cameras (e.g., front and rear view images from different fisheye cameras) that may vary significantly in terms of noise and distortion. These techniques are limited only by any irreducible error attributable to the 3D points being from different parts of an object (which is inherent to using different cameras in different locations, and therefore required to improve density of the point cloud of an object).

Once trained on point clouds generated from different sensor, the registration neural network can generalize to any new point cloud generated from those sensors and does not need to be retrained to merge the new point clouds.

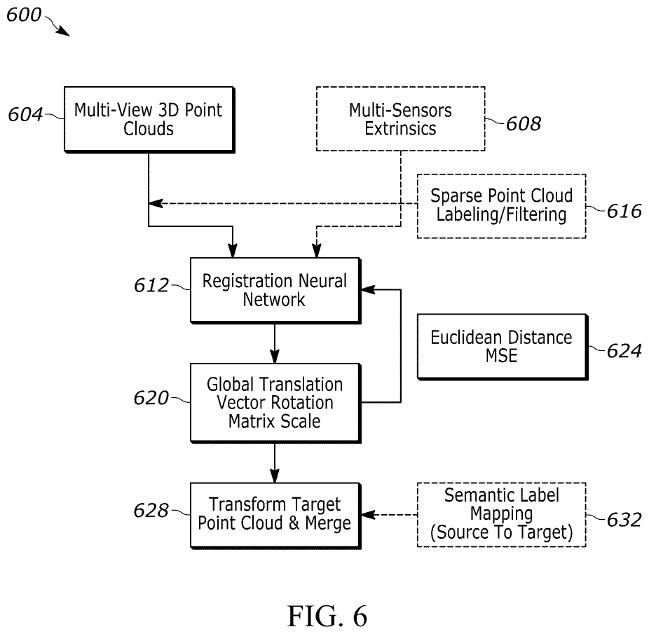

FIG. 6 is an example cloud merging process 600 according to the principles of the present disclosure. Functions of the process 600 can be performed by one or more computing devices, systems, processors or processing devices, etc. as described herein (e.g., one or more components of the system 100). As one example, all or portions of the process 600 may correspond to mapping functions (e.g., as shown at 216) performed by the mapping system 106.

At 604, multi-view 3D point clouds are obtained from respective cameras/sensors. For example, to perform the cloud merging techniques of the present disclosure, point clouds are obtained from at least two different cameras arranged at different locations/positions of a vehicle. Accordingly, respective point clouds represent a same image or scene from different viewpoints/perspectives. The respective point clouds include different distortion from the different cameras.

In some examples, multi-sensor extrinsics (extrinsic data) are obtained or determined as shown at 608. As used herein, “extrinsics” or “extrinsic data” refer to external sensor/camera characteristics for the cameras used to obtain the point clouds. For example, the extrinsic data includes information such as locations of the cameras (e.g., in an xyz coordinate plane corresponding to the vehicle), orientations of the cameras, positional relationships of the cameras relative to each other, and so on.

At 612, the point clouds and the extrinsic data are provided to a machine learning (ML) or deep learning (DL) model, such as a registration neural network. For example, the registration neural network is a 3-layer registration neural network configured to perform image registration and translation. As used herein, “image registration” refers to performing alignment of two or more images of a same scene or object (e.g., as represented by the point clouds obtained using a same camera at different times, different cameras at different locations/orientations on the vehicle, etc.). In some examples, the point clouds obtained at 604 (e.g., sparse point clouds) are filtered to reduce noise (e.g., via segmentation) as shown at 616, prior to being provided to the registration neural network 612.

The registration neural network is configured to use the point clouds and the extrinsic data to learn/obtain one or more transformation characteristics/relationships. The transformation characteristics define relationships between the different cameras and point clouds obtained using the different cameras and therefore provide information that can be used to map points in one point cloud to corresponding points in another point cloud, preserving initial spatial relationships of both point clouds on an object-to-object basis. In other words, point locations on individual objects in the point clouds are preserved, object position relative to other objects is preserved, and any distortion resulting from the different images being captured from different cameras is removed.

As one example, the registration neural network is configured to generate, as the transformation characteristics, one or more of a global translation vector, a rotation matrix, and a scale factor defining relationships between two or more point clouds and respective cameras as shown at 620. For example, these transformation characteristics are generated to minimize a Euclidean distance between a point from a target point cloud and a point from a source point cloud (e.g., using mean squared error, or MSE, techniques) as shown at 624, learning a correct transformation to map the target point cloud onto the source point cloud. For example only, the source point cloud corresponds to a point cloud obtained from a first camera and the target point cloud corresponds to a point cloud obtained from a second camera. For example, each pair of cameras may have an associated translation vector, rotation matrix, and/or scale factor.

For example, the translation vector is a 3D vector that defines spatial relationships (e.g., distances and directions) between points in point clouds for different cameras. Accordingly, the translation vector indicates how each point in one point cloud can be shifted (in both direction and distance along x, y, and z axes) to be merged with a corresponding point in another point cloud (i.e., the translation vector shifts all points in the source cloud in the x, y, and z directions to align with the target cloud). The global translation vector obtained by the registration neural network according to the present disclosure is configured to translate between any point clouds subsequently obtained by respective cameras during operation.

The rotational matrix defines a rotational relationship between point clouds obtained by different cameras. For example, each matrix may be a 3×3 matrix defining an angle of rotation corresponding to two different cameras (e.g., an angle or rotation corresponding to different rotational orientations/perspectives of two different cameras). Accordingly, the rotation matrix rotates points in the source cloud around a reference point (e.g., the origin).

The scale factor defines a scaling/size relationship between the point clouds. For example, the scale factor indicates an amount that a point cloud obtained from one camera is reduced or enlarged relative to a point cloud obtained from another camera. Accordingly, the scale factor uniformly scales the size of the source point cloud. When scaling is applied, the transformation becomes a similarity transformation.

At 628, the target point cloud is transformed and merged with the source point cloud, using the transformation characteristics, to obtain/output a merged point cloud. The merged point cloud is a point cloud for a merged image corresponding to two or more images obtained from respective cameras. In some examples, semantic labels are added to the target point cloud using labels from the source point cloud as shown at 632. For example, K-Nearest-Neighbors (e.g., meshing, smoothing, graph neural network, etc.) techniques can be used to add semantic labels to the target point cloud from the nearest labeled point in the source point cloud if labels are not provided in the target point cloud.

In other aspects described above, systems and methods according to the present disclosure are configured to perform feature matching techniques to match features from different images (e.g., images obtained from different cameras as described above and/or images obtained at different times from the same camera). Systems and methods according to the present disclosure may be further configured to implement feature matching techniques that facilitate self-supervised deep feature matching of semantic feature points by leveraging the scalability of vision transformers (ViTs) to enhance the accuracy and robustness of feature matching.

In an example, feature extraction and segmentation algorithms are applied to images obtained by one or more cameras. For example, SIFT or other semantic feature extraction techniques include sampling contours of segmentations of objects of interest to obtain feature points required to match features between images (e.g., an original or source image and a target image). The segmentation can be merged with the original image to increase contrast and feature detectability for SIFT.

A patch or region around each feature point in the original image is provided as input to a vision transformer (ViT). The segmentation can be used to perform semi-supervised (e.g., both labeled and unlabeled) triplet matching in which a keypoint in the source image functions as an anchor, the patch from the original image functions as the positive, and a randomly-selected feature point that is of a different class than the feature point in the original image functions as the negative. As used herein, triplet matching refers to a triplet matching technique for learning features of an image. In various examples, a “triplet” includes an anchor (e.g., a reference image), a positive (e.g., an image similar to the anchor image, such as an image of an object in the anchor image from a different perspective), and a negative (e.g., an image of a different object than the object in the anchor image). Triple matching is performed to learn feature embedding characteristics that (i) minimize a distance between features in the anchor and features in the positive and (ii) maximize a distance between features in the anchor and features in the negative. As one example, triple matching includes: extracting features from each image in the triplet (e.g., using a neural network); calculating distances between feature vectors of the anchor, positive, and negative; and applying a triplet loss function to a corresponding model (e.g., a model corresponding to the neural network).

As implemented by the systems and methods of the present disclosure, fine tuning the positive can be changed to a mapping of the source feature point to a future image feature point. The mapping of the source feature point is configured to account for frameshift and segmentation contours use Euclidean distance to map to a nearest point. Further, the negative can be shifted to a random feature point of the same class as the source point to enrich the descriptor space.

In this manner, triplet matching is performed to obtain a triplet database of semantic features. The vision transformer can be trained using the triplet database and various contrastive loss techniques (e.g., triplet loss). Self-supervised training allows high scalability and a minimum requirement of a sequence of images that are of interest. The vision transformer, once trained, outputs semantic descriptors that can be matched with similarity metrics (e.g., Euclidean distance, cosine similarity, etc.).

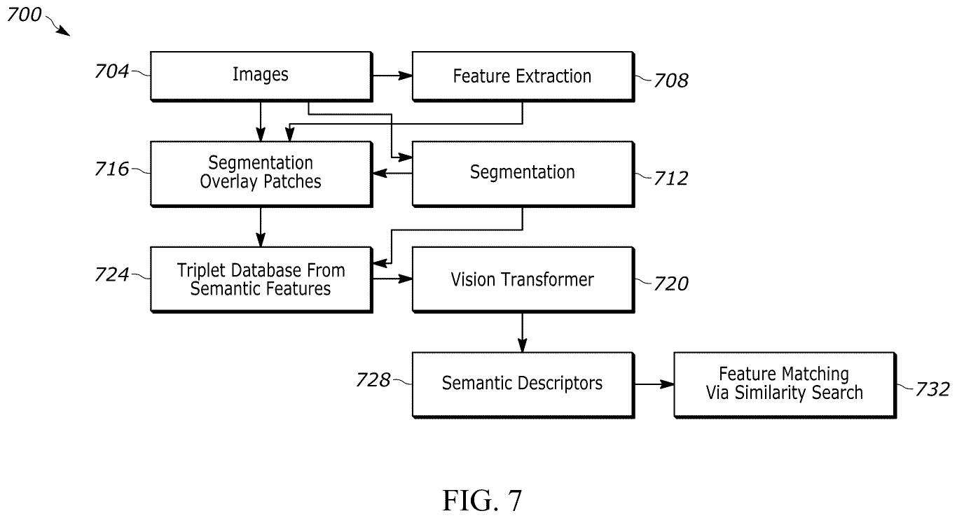

FIG. 7 is an example feature matching process 700 according to the principles of the present disclosure. Functions of the process 700 can be performed by one or more computing devices, systems, processors or processing devices, etc. as described herein (e.g., one or more components of the system 100). As one example, all or portions of the process 700 may correspond to functions performed during image domain deep learning as shown at 202, functions performed by a CV model as shown at 206, functions performed during semantic segmentation as shown at 208, etc.

At 704, images are obtained from one or more cameras (e.g., successive images from a same camera, images from different cameras, etc., which may include at least one source/original image and at least one target image). Feature extraction (at 708) and segmentation (at 712) algorithms are applied to the images. For example, SIFT or other semantic feature extraction techniques may include sampling contours of segmentations of objects of interest to obtain feature points required to match features between images. Accordingly, the segmentation performed at 712 includes obtaining segmentation contours.

The segmentation can be merged with the original image to increase contrast and feature detectability for SIFT. For example, at 716, segmentation overlay patches are embedded around one or more portions of the source image using results of the feature extraction (e.g., identified feature points) and segmentation (e.g., segmentation contours). The segmentation overlay patches are embedded around a patch or region corresponding to an identified feature point in the original image. As one example, embedding a segmentation overlay patch may include overlaying a specific, selected color onto/within one or more regions of the source image including respective feature points (e.g., within a region defined by a segmentation contour).

The embedded patches or regions around each feature point, along with the original/source image, are provided as input to a vision transformer (ViT) as shown at 720. The segmentation can be used to perform self-or semi-supervised (e.g., both labeled and unlabeled) triplet matching. For example, feature embedding characteristics of images are learned using triplets of anchors, positives, and negatives to form a triplet database of semantic features as shown at 724.

The ViT may be trained using the triplet database of semantic features (e.g., using triplet loss or other contrastive loss techniques) in a self-supervised manner. This self-supervised training allows for high scalability, requiring only a sequence of images of interest during subsequent tasks. In this manner, the trained ViT is configured to output, based on a sequence of images, semantic descriptors as shown at 728, which are then matched using similarity metrics such as Euclidean distance or cosine similarity as shown at 732. The matched semantic descriptors (which correspond to matched features between images in a sequence of images) can then be used to identify matched features in subsequent images, merged images (e.g., in a BEV), etc.

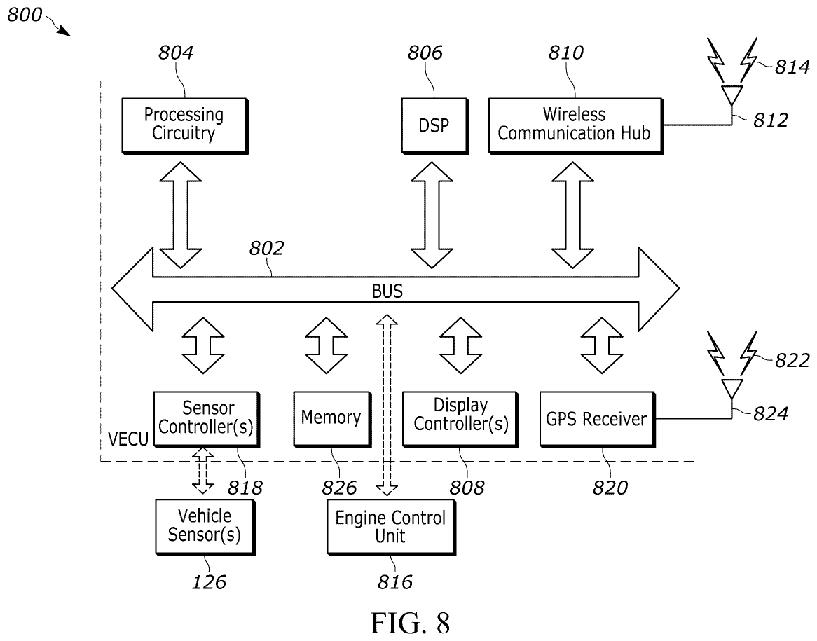

FIG. 8 is a block diagram of internal components of an exemplary embodiment of a computing system 800. The computing system 800 may include or be used to implement the computing systems described above. In this embodiment, the computing system 800 may be embodied at least in part in a vehicle electronics control unit (VECU). It should be noted that FIG. 8 is meant only to provide a generalized illustration of various components, any or all of which may be utilized as appropriate. It can be noted that, in some instances, components illustrated by FIG. 8 can be localized to a single physical device and/or distributed among various networked devices, which may be disposed at different physical locations.

The computing system 800 has hardware elements that can be electrically coupled via a BUS 802. The hardware elements may include processing circuity 804 which can include, without limitation, one or more processors, one or more special-purpose processors (such as digital signal processing (DSP) chips, graphics acceleration processors, application specific integrated circuits (ASICs), and/or the like), and/or other processing structure or means. The above-described processors can be specially-programmed to perform the operations disclosed herein, including, among others, image processing, data processing, and implementation of the machine learning models described above. Some embodiments may have a separate DSP 806, depending on desired functionality. The computing system 800 can also include one or more display controllers 808, which can control the display devices disclosed above, such as an in-vehicle touch screen, screen of a mobile device, and/or the like.

The computing system 800 may also include a wireless communication hub 810, or connectivity hub, which can include a modem, a network card, an infrared communication device, a wireless communication device, and/or a chipset (such as a Bluetooth device, an IEEE 802.11 device, an IEEE 802.16.4 device, a WiFi device, a WiMax device, cellular communication facilities including 4G, 5G, etc.), and/or the like. The wireless communication hub 810 can permit data to be exchanged with network 114, wireless access points, other computing systems, etc. The communication can be carried out via one or more wireless communication antenna 812 that send and/or receive wireless signals 814.

The computing system 800 can also include or be configured to communicate with an engine control unit 816, or other type of controller 108 described herein. In the case of a vehicle that does not include an internal combustion engine, the engine control unit may instead be a battery control unit or electric drive control unit configured to command propulsion of the vehicle. In response to instructions received via the wireless communications hub 810, the engine control unit 816 can be operated in order to control the movement of the vehicle during, for example, a parking procedure.

The computing system 800 also includes vehicle sensors 126 such as those described above with reference to FIG. 1. These sensors can include, without limitation, one or more accelerometer(s), gyroscope(s), camera(s), radar(s), LiDAR(s), odometric sensor(s), and ultrasonic sensor(s), as well as magnetometer(s), altimeter(s), microphone(s), proximity sensor(s), light sensor(s), and the like. These sensors can be controlled via associated sensor controller(s) 818.

The computing system 800 may also include a GPS receiver 820 capable of receiving signals 822 from one or more GPS satellites using a GPS antenna 824. The GPS receiver 820 can extract a position of the device, using conventional techniques, from satellites of an GPS system, such as a global navigation satellite system (GNSS) (e.g., Global Positioning System (GPS)), Galileo, GLONASS, Compass, Galileo, Beidou and/or other regional systems and/or the like.

The computing system 800 can also include or be in communication with a memory 826. The memory 826 can include, without limitation, local and/or network accessible storage, a disk drive, a drive array, an optical storage device, a solid-state storage device, such as a RAM which can be programmable, flash-updateable and/or the like. Such storage devices may be configured to implement any appropriate data stores, including without limitation, various file systems, database structures, and/or the like. The memory 826 can also include software elements (not shown), including an operating system, device drivers, executable libraries, and/or other code embedded in a computer-readable medium, such as one or more application programs, which may comprise computer programs provided by various embodiments, and/or may be designed to implement methods, and/or configure systems, provided by other embodiments, as described herein. In an aspect, then, such code and/or instructions can be used to configure and/or adapt a general purpose computer (or other device) to perform one or more operations in accordance with the described methods, thereby resulting in a special-purpose computer.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. These memory devices may be non-transitory computer-readable storage mediums for storing computer-executable instructions which, when executed by one or more processors described herein, can cause the one or more processors to perform the techniques described herein. The processor and the memory can be supplemented by, or incorporated in, special purpose logic circuitry.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of performing feature matching to map an environment of a vehicle, the method comprising:
generating image-domain data based on image data received from a plurality of cameras mounted on the vehicle, wherein the image-domain data includes data corresponding to a plurality of images;
performing feature extraction on a first image of the plurality of images to identify and extract features from the first image;
performing segmentation on the first image to identify contours around the extracted features;
embedding one or more patches in the first image based on the identified contours to obtain a merged image;
providing the merged image to a vision transformer; and
using the vision transformer to (i) generate semantic descriptors for the merged image and (ii) perform feature matching to match, based on the semantic descriptors, the first image to a second image of the plurality of images.

2. The method of claim 1, wherein the image data is associated with a parking zone outside the vehicle, and wherein the image-domain data is generated by a feature-detection machine learning model.

3. The method of claim 1, further comprising generating a bird's-eye-view (BEV) image based on results of the feature matching, wherein the BEV image is a projected image of a parking zone.

4. The method of claim 3, further comprising:
generating BEV-domain data associated with the BEV image, wherein the BEV-domain data includes data associated with parking landmarks in the parking zone;
localizing the vehicle within the parking zone based on the BEV-domain data and the image-domain data to generate localization data; and
mapping the parking zone based on the BEV-domain data, the image-domain data, and the localization data.

5. The method of claim 4, wherein the localizing and the mapping are performed by a simultaneous localization and mapping (SLAM) system.

6. The method of claim 1, further comprising using a feature-detection machine learning model to perform semantic segmentation on the image data to extract the features from the first image.

7. The method of claim 1, wherein the performing feature extraction includes using at least one of scale invariant feature transform (SIFT) techniques and semantic segmentation techniques.

8. The method of claim 1, wherein the embedding one or more patches includes overlaying a selected first color onto a region including one or more of the extracted features.

9. The method of claim 1, further comprising:
obtaining a first point cloud from a first camera of the plurality of cameras;
obtaining a second point cloud from a second camera of the plurality of cameras;
obtaining transformation characteristics defining a relationship between the first camera and the second camera; and
merging the first point cloud with the second point cloud based on the transformation characteristics.

10. The method of claim 1, further comprising:
issuing vehicle control commands to control movement of the vehicle based on the match of the first image to the second image.

11. A system for performing feature matching to map an environment of a vehicle, the system comprising:
a plurality of image sensors configured to be mounted to the vehicle and to generate image data;
one or more processors; and
memory coupled to the one or more processors, the memory storing instructions that, when executed by the one or more processors, cause the one or more processors to:
generate image-domain data based on image data received from the plurality of image sensors, wherein the image-domain data includes data corresponding to a plurality of images;
perform feature extraction on a first image of the plurality of images to identify and extract features from the first image;
perform segmentation on the first image to identify contours around the extracted features;
embed one or more patches in the first image based on the identified contours to obtain a merged image;
provide the merged image to a vision transformer; and
use the vision transformer to (i) generate semantic descriptors for the merged image and (ii) perform feature matching to match, based on the semantic descriptors, the first image to a second image of the plurality of images.

12. The system of claim 11, wherein the image data is associated with a parking zone outside the vehicle, and wherein the image-domain data is generated by a feature-detection machine learning model.

13. The system of claim 11, wherein the instructions further cause the one or more processors to generate a bird's-eye-view (BEV) image based on results of the feature matching, wherein the BEV image is a projected image of a parking zone.

14. The system of claim 13, wherein the instructions further cause the one or more processors to:
generate BEV-domain data associated with the BEV image, wherein the BEV-domain data includes data associated with parking landmarks in the parking zone;
localize the vehicle within the parking zone based on the BEV-domain data and the image-domain data to generate localization data; and
map the parking zone based on the BEV-domain data, the image-domain data, and the localization data.

15. The system of claim 14, wherein the localize and the map are performed by a simultaneous localization and mapping (SLAM) system.

16. The system of claim 11, wherein the instructions further cause the one or more processors to use a feature-detection machine learning model to perform semantic segmentation on the image data to extract the features from the first image.

17. The system of claim 11, wherein the perform feature extraction further includes using at least one of scale invariant feature transform (SIFT) techniques and semantic segmentation techniques.

18. The system of claim 11, wherein the embed one or more patches includes overlaying a selected first color onto a region including one or more of the extracted features.

19. The system of claim 11, wherein the instructions further cause the one or more processors to:
obtain a first point cloud from a first image sensor of the plurality of image sensors;
obtain a second point cloud from a second image sensor of the plurality of image sensors;
obtain transformation characteristics defining a relationship between the first image sensor and the second image sensor; and
merge the first point cloud with the second point cloud based on the transformation characteristics.

20. A non-transitory computer-readable storage medium storing one or more programs, the one or more programs comprising instructions which, when executed by one or more processors of an electronic device, cause the electronic device to perform feature matching to map an environment of a vehicle by:
generating image-domain data based on image data received from a plurality of cameras mounted on the vehicle, wherein the image-domain data includes data corresponding to a plurality of images;
performing feature extraction on a first image of the plurality of images to identify and extract features from the first image;
performing segmentation on the first image to identify contours around the extracted features;
embedding one or more patches in the first image based on the identified contours to obtain a merged image;
providing the merged image to a vision transformer; and
using the vision transformer to (i) generate semantic descriptors for the merged image and (ii) perform feature matching to match, based on the semantic descriptors, the first image to a second image of the plurality of images.
